(19) United States
(12) Patent Application Publication
(10) Pub. No.: US 2026/0082434 A1
(43) Pub. Date: Mar. 19, 2026

(54) BACKOFF INDICATION FOR ADDITIONAL PHYSICAL RANDOM ACCESS CHANNEL RESOURCES ASSOCIATED WITH NETWORK ENERGY SAVINGS OR SUBBAND NON-OVERLAPPING FULL DUPLEX

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/889,009

(22) Filed: Sep. 18, 2024

(51) Int. Cl. H04W 74/0833; H04L 5/14; H04W 52/02; H04W 74/00

(52) U.S. Cl. CPC H04W 74/085; H04L 5/14; H04W 52/0203; H04W 74/006

(57) ABSTRACT

Systems and techniques are provided for wireless communications. A network entity can transmit a first configuration of a backoff indicator (BI) associated with a prioritized random access procedure, the first configuration corresponding to a first type of random access channel (RACH) occasions (ROs). The network entity can transmit a second configuration of the BI, the second configuration corresponding to a second type of ROs different from the first type of ROs. The network entity can transmit, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

### INTRODUCTION

Aspects of the present disclosure generally relate to wireless communication. In some implementations, examples are described for physical random access channel (PRACH) resource configurations using additional PRACH resources corresponding to one or more of network energy savings (NES) and/or subband non-overlapping full duplex (SBFD) implementations for a user equipment (UE).

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a network entity for wireless communication is provided. The network entity includes at least one memory and at least one processor coupled to the at least one memory. The network entity is configured to: transmit a first configuration of a backoff indicator (BI) associated with a prioritized random access procedure, wherein the first configuration of the BI corresponds to a first type of random access channel (RACH) occasions (ROs); transmit a second configuration of the BI, wherein the second configuration of the BI corresponds to a second type of ROs different from the first type of ROs; and transmit, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

In another example, a method for wireless communication is provided, the method including: transmitting a first configuration of a backoff indicator (BI) associated with a prioritized random access procedure, wherein the first configuration of the BI corresponds to a first type of random access channel (RACH) occasions (ROs); transmitting a second configuration of the BI, wherein the second configuration of the BI corresponds to a second type of ROs different from the first type of ROs; and transmitting, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

In another example, a non-transitory computer-readable storage medium comprising instructions stored thereon which, when executed by at least one processor, causes the at least one processor to: transmit a first configuration of a backoff indicator (BI) associated with a prioritized random access procedure, wherein the first configuration of the BI corresponds to a first type of random access channel (RACH) occasions (ROs); transmit a second configuration of the BI, wherein the second configuration of the BI corresponds to a second type of ROs different from the first type of ROs; and transmit, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

In another example, an apparatus is provided for wireless communication. The apparatus includes: means for transmitting a first configuration of a backoff indicator (BI) associated with a prioritized random access procedure, wherein the first configuration of the BI corresponds to a first type of random access channel (RACH) occasions (ROs); means for transmitting a second configuration of the BI, wherein the second configuration of the BI corresponds to a second type of ROs different from the first type of ROs; and means for transmitting, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment (UE), in accordance with some examples;

FIG. 5 is a diagram illustrating an example of physical channels and reference signals in a wireless network, in accordance with some examples;

FIG. 6 is a diagram illustrating an example of a plurality of random access channel (RACH) occasions (ROs) of a first type and a plurality of ROs of a second type configured based on corresponding backoff indications (BIs), in accordance with some examples;

FIG. 7 is a flow diagram illustrating an example of a process for wireless communication, in accordance with some examples; and

FIG. 8 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, physical channels can correspond to sets of time-frequency resources used for transmission of particular transport channel data, control information, or indicator information. For instance, each transport channel can be mapped to a corresponding physical channel. The physical downlink shared channel (PDSCH) may carry and/or be used to communicate user data and paging information to a user equipment (UE) or other terminal. The physical downlink control channel (PDCCH) may carry and/or be used to communicate control information, including scheduling decisions for PDSCH reception, and/or for scheduling grants enabling transmission on the physical uplink shared channel (PUSCH), etc. The physical broadcast channel (PBCH) may carry broadcasts of network information utilized by UEs establishing a connection with the network. For example, the PBCH may carry and/or be used to communicate a Master Information Block (MIB), where the MIB includes various network configuration parameters that can be used by a UE to perform initial access to the network.

Physical random access channel (PRACH) signals and communications can be used by a UE to perform a random access procedure with a base station or other network entity. For example, PRACH signals and communications can be used to perform a random access procedure to align the uplink transmissions of the UE to a base station or gNB and gain access to (e.g., connect to) a wireless network associated with the base station or gNB. For example, PRACH can be used for initial access requests from a UE to a base station and to obtain time synchronization. To access the network, the UE can request access by transmitting a random access (RA) preamble through PRACH. The RA preamble can be detected by a PRACH receiver at the base station, which estimates the ID of the transmitted preamble and a propagation delay between the UE and the base station. The base station and UE are then time-synchronized according to a time alignment (TA) value (e.g., determined from the propagation delay estimate) transmitted from the base station prior to the uplink transmission.

PRACH resources can refer to time-frequency resources allocated for transmitting random access preambles. RACH occasions (ROs) can correspond to the particular time intervals (e.g., particular time and frequency resources) available to a UE for transmitting PRACH messages. For example, a UE can transmit a PRACH message during a configured RO and using configured PRACH resources. As used herein, an RO can refer to a RACH occasion and/or a PRACH occasion.

Multiple ROs may be associated with each synchronization signal block (SSB). PRACH resources and ROs can be configured using a PRACH configuration period, indicative of how often PRACH resources are available. An association period can be indicative of a mapping between SSBs and ROs over time. In some examples, ROs can be multiplexed in the frequency domain, for example using a frequency division multiplexing (FDM) RO configuration where multiple ROs are available in one time instance. In some cases, PRACH resources and ROs can be configured with a time domain allocation, indicative of a first physical uplink shared channel (PUSCH) available after a PRACH slot.

PRACH occasions (e.g., ROs) can be shared between different RACH procedures. For example, ROs can be shared between 2-step and 4-step RACH procedures, etc. In some cases, additional PRACH resources and/or PRACH occasions (e.g., ROs) may be configured. For example, additional PRACH resources and/or PRACH occasions (e.g., ROs) may be configured for network energy savings (NES) implementations, among various other dynamic adaptations of PRACH in the time domain. In some examples, additional PRACH resources and/or PRACH occasions (e.g., ROs) may be configured for subband non-overlapping full duplex (SBFD) operation by a network entity (e.g., base station, gNB, etc.) within a time division duplexing (TDD) carrier.

NES may be used to reduce power consumption in 5G NR networks, and can be based on the use of one or more power saving techniques, such as on-demand SSB transmission in secondary cells, adaptation of the periodicity of SSB, paging occasion, and random access occasion based on network conditions, etc. In some cases, NES techniques may be implemented based on the adaptation of SSB in the time domain (e.g., adapting periodicity), the adaptation of PRACH in the time domain, and/or the adaptation of PRACH in the spatial domain (e.g., non-uniform PRACH resources per SSB, etc.). NES implementations can be implemented without negative impact to legacy UEs, where the legacy UEs are UEs that do not support the NES technique(s) of the NES implementation. In some cases, an NES-based adaptation of PRACH in the time-domain can be associated with additional PRACH resources that are configured for NES-capable UEs. The additional PRACH resources can be in addition to the PRACH resources configured for legacy UEs (e.g., non-NES-capable UEs). NES-capable UEs can utilize the additional PRACH resources and the PRACH resources configured for legacy UEs. In some examples, the configuration of the additional PRACH resources for NES-capable UEs can be provided and/or indicated by semi-static signaling transmitted from a network entity (e.g., base station, gNB, etc.). The additional PRACH resources for NES-capable UEs may be overlapping or non-overlapping with the PRACH resources for legacy (e.g., non-NES-capable) UEs. The additional PRACH resources for NES-capable UEs can be implemented without changes to the PRACH configuration tables used by and associated with the PRACH resources for legacy UEs.

SBFD is a duplex mode that can be used to provide simultaneous transmission and reception on non-overlapping subbands within the same frequency band. For example, a network entity (e.g., base station, gNB, etc.) can use SBFD to transmit and receive simultaneously on different subbands. UEs communicating with a network entity that is using SBFD operation may continue to perform half-duplex mode communications (e.g., the UEs may utilize half-duplex mode communications for a network entity that does implement SBFD operations, and for a network entity that does not implement SBFD operations). In some examples, a network entity may perform SBFD operations within a TDD carrier. For example, the network entity can provide a semi-static indication of the time location(s) of SBFD subbands to UEs in a radio resource control (RRC) connected mode. In some cases, the indication of the time location(s) of SBFD subbands can be provided within a system information block (SIB). In some cases, the network entity can provide a semi-static indication of the frequency domain location(s) of SBFD subbands to UEs in the RRC connected mode. In some examples, the indication of the frequency location(s) of SBFD subbands can be provided within a SIB. In some examples, SBFD operations by a network entity (e.g., to a UE) can be configured to support random access in SBFD symbols by UEs in RRC connected mode. In some examples, SBFD operations by a network entity (e.g., to a UE) can be configured for a UE in RRC idle and/or RRC inactive mode(s) for random access.

In some examples, SBFD operations by a network entity can be used to reduce uplink (UL) bottlenecks or congestion that may be associated with non-SBFD (e.g., legacy) TDD schemes for communications between UEs and a network entity. A network entity that does not implement SBFD may use separate downlink and uplink slots, where PRACH occasions (e.g., ROs) within a downlink slot are treated as invalid (e.g., the valid ROs for a UE are within the uplink slots configured by or for the non-SBFD network entity).

For random access operation for SBFD-aware UEs (e.g., also referred to herein as SBFD-capable UEs) in an RRC connected state, additional PRACH occasions (e.g., ROs) may be configured, corresponding to the ROs that were previously treated as invalid based on being within a downlink slot of a network entity. For example, a network entity implementing SBFD operations can perform simultaneous transmission and reception using a plurality of SBFD symbols or SBFD slots, rather than using separate uplink and downlink slots.

In some examples, random access operations for SBFD-capable UEs in an RRC connected state can be configured based on a single RACH configuration transmitted by the network entity. The single RACH configuration can indicate that the ROs within the UL subband in SBFD symbols are valid for SBFD-capable UEs. In some cases, the ROs within the UL subband in SBFD symbols can be configured as invalid for non-SBFD-capable UEs (e.g., legacy UEs). The ROs within the UL subband in SBFD symbols can be referred to as additional ROs (e.g., additional PRACH resources), where the additional ROs are associated with SBFD.

In some examples, random access operations for SBFD-capable UEs in an RRC connected state can be configured based on two separate RACH configurations. A first RACH configuration can be used to indicate RACH configuration information corresponding to non-SBFD-capable UEs (e.g., legacy UEs) and/or the ROs within the UL subband in non-SBFD symbols. A second RACH configuration can be used to indicate RACH configuration information corresponding to SBFD-capable UEs and/or the ROs within the UL subband in SBFD symbols. For example, the ROs within the UL subband in SBFD symbols can be referred to as additional ROs for SBFD and/or SBFD-capable UEs, and can be configured by the additional (e.g., second) RACH configuration. The ROs within the UL subband in SBFD symbols configured by the additional RACH configuration can be configured as valid for the SBFD-capable UEs, and invalid for the non-SBFD-capable (e.g., legacy) UEs. The ROs within the UL subband in non-SBFD symbols can be valid for both the SBFD-capable UEs and the non-SBFD-capable (e.g., legacy) UEs.

Random Access (RA) prioritization is a technique in 5G NR that can be used to manage and prioritize the access of different services and/or UEs to the network. For example, RA prioritization can be used to manage and prioritize network access in examples where network resources are limited, heavily utilized, congested, etc. In some examples, RA prioritization can be configured and/or implemented based on configuration information included within an RA-Prioritization Information Element (IE). For example, the RA-Prioritization IE may include one or more fields indicative of configured values or parameters for configuring prioritized random access. The RA-Prioritization IE can indicate how different RA requests are prioritized by the network.

For example, the RA-Prioritization IE can include a powerRampingStepHighPriority field, indicative of a power ramping step applied for a prioritized random access procedure. The power ramping step can indicate a power increment (e.g., as a dB value, etc.) used by a UE during the RA procedure when a high-priority access is required. The RA-Prioritization IE may include a scalingFactorBI field, indicative of a scaling factor for a backoff indicator (BI) for the prioritized random access procedure. The BI scaling factor may be a value between zero and 1, and can be selected from a plurality of configured candidate values for the BI scaling factor (e.g., 0, 0.25, 0.50, 0.75, etc.). The configured BI scaling factor can be used as a scaling factor for the BI during the random access procedure by a UE. For example, the scalingFactorBI can be used to modify the backoff time for random access attempts by a UE. The BI is an indication transmitted in the Random Access Response (RAR) sent from a network entity (e.g., base station, gNB, etc.) to a UE, in response to the network entity receiving an RA preamble transmitted through PRACH by the UE.

As noted above, NES-capable UEs can be configured with additional PRACH resources and/or additional PRACH occasions (e.g., ROs), where the additional PRACH resources are in addition to the PRACH resources and ROs configured for non-NES-capable (e.g., legacy) UEs, and may be activated based on the network load. SBFD-capable UEs can perform communications during SBFD slots associated with a network entity, in addition to uplink and downlink slots associated with the network entity. The PRACH resources and/or PRACH occasions (e.g., ROs) within the SBFD slots of the network entity can be configured as additional PRACH resources and/or additional ROs, in addition to the PRACH resources and ROs configured within the non-SBFD uplink and downlink slots of the network entity. There is a need for systems and techniques that can be used to provide a first backoff indication configuration corresponding to a first type of PRACH resources and ROs, and a second backoff indication configuration corresponding to a second type of PRACH resources and ROs. For example, there is a need for systems and techniques that can be used to provide a first backoff indication configuration for legacy PRACH resources and ROs, and a second backoff indication configuration for additional PRACH resources and ROs, including the additional PRACH resources and ROs associated with NES and/or SBFD.

Systems, apparatuses, processes (also referred to as methods), and computer-readable media (collectively referred to as “systems and techniques”) are described herein that can be used to configure a backoff indicator (BI) for one or more UEs based on a type of PRACH resource and/or PRACH occasion (e.g., RO) associated with the BI. For example, the systems and techniques can be used to provide a first BI configuration corresponding to a first type of PRACH occasions and a second BI configuration corresponding to a second type of PRACH occasions. In some cases, the systems and techniques can be used to provide a first backoff indication configuration for legacy PRACH resources and ROs (e.g., PRACH resources and ROs not associated with NES and/or SBFD), and a second backoff indication configuration for additional PRACH resources and ROs, including the additional PRACH resources and ROs associated with NES and/or SBFD.

In some examples, the second BI configuration can be used to configure a backoff indication and/or RA prioritization for additional ROs associated with one or more of Network Energy Savings (NES) and/or subband non-overlapping full duplex (SBFD) communications between a network entity and a UE. The first BI configuration can be used to configure a backoff indication and/or RA prioritization for ROs not associated with NES and/or SBFD. In some cases, the first and second BI configurations can be used to configure a relatively shorter backoff time length for UEs transmitting a PRACH using one or more of the additional ROs, and a relatively longer backoff time length for UEs transmitting a PRACH using ROs that are not included in the additional ROs.

For example, the first and second BI configurations can be used to configure a relatively shorter backoff time length for NES-capable UEs transmitting a PRACH using an additional RO that is configured semi-statically by a network entity (e.g., base station, gNB, etc.) and activated by the network entity based on network load, where the backoff time length for the NES-capable UEs is shorter than the backoff time length for a non-NES-capable (e.g., legacy) UE. In another example, the first and second BI configurations can be used to configure a relatively shorter backoff time length for SBFD-capable UEs transmitting a PRACH using an additional RO (e.g., an SBFD RO) that corresponds to PRACH resources within an SBFD slot of the network entity, where the backoff time length for the SBFD-capable UE is shorter than the backoff time length for a non-SBFD-capable (e.g., legacy) UE.

In some examples, the systems and techniques can be configured to provide separate backoff indicators for different types of ROs (e.g., additional ROs, and non-additional ROs). For example, a network entity can transmit (and a UE can receive) first information indicative of a first backoff indicator corresponding to a first type of ROs (e.g., non-additional ROs, including ROs that are not associated with NES or SBFD). The network entity can transmit (and the UE can receive) second information indicative of a second backoff indicator corresponding to a second type of ROs (e.g., additional ROs configured and activated for NES-capable UEs, and/or additional ROs comprising SBFD ROs using PRACH resources within SBFD slots).

In some cases, a network entity can indicate a backoff indicator value to a UE as an index value, where the UE is configured to determine a corresponding backoff parameter value (e.g., a backoff time length or duration) based on comparing the received index value with configured mapping information between a plurality of indices and a plurality of corresponding backoff parameter values. In some examples, a backoff indication can be determined for a first type of ROs based on comparing the received index value to a first configured mapping information associated with legacy ROs (e.g., non-additional ROs that are not associated with NER and/or SBFD), and a backoff indication can be determined for a second type of ROs based on comparing the received index value to a second configured mapping information associated with additional ROs (e.g., additional ROs configured and activated for NER, SBFD ROs, etc.).

In some examples, an NER-capable and/or SBFD-capable UE can receive RRC configuration information indicative of an offset to apply to a received backoff indication value. For example, the NER-capable and/or SBFD-capable UE can apply the indicated offset determined from the RRC configuration to the received backoff indication value, to thereby determine the configured backoff for the NER-capable and/or SBFD-capable UE. In some examples, the offset can be signaled as a time offset (e.g., a number of milliseconds the NER-capable and/or SBFD-capable UE backoff indication is offset from the legacy UE backoff indication that is received from the network entity). In some examples, the offset can be signaled as an offset for the backoff indication index value, where the NER-capable and/or SBFD-capable UE receives a backoff index value from the network entity and corresponding to legacy ROs, applies the signaled offset to the received backoff index value to determine an updated backoff index value, and compares the updated backoff index value to the mapping information between index values and backoff durations to obtain the configured backoff duration for the NER-capable and/or SBFD-capable UE.

In some examples, a single configured mapping information can be used to indicate, for each respective backoff index value of a plurality of backoff index values, a corresponding backoff duration (e.g., backoff parameter value) for legacy UEs and a corresponding backoff duration (e.g., backoff parameter value) for NER-capable and/or SBFD-capable UEs. For example, to implement a first BI configuration for legacy UEs and a second BI configuration for NER-capable and/or SBFD-capable UEs, the configured mapping information can map each backoff index value to a first backoff duration associated with the first BI configuration and a second backoff duration associated with the second BI configuration.

In some aspects, the first and second BI configurations can be implemented using the same received BI information (e.g., the same received backoff parameter value or backoff index value mapped to a corresponding backoff parameter value), where the first BI configuration is implemented based on applying a first BI scaling factor to the received BI information, and the second BI configuration is implemented based on applying a second BI scaling factor to the received BI information. For example, the first BI scaling factor can be used by legacy UEs (e.g., non-NER-capable UEs and/or non-SBFD-capable UEs) to determine a configured BI for transmitting a PRACH on a legacy RO. The second BI scaling factor can be different from the first BI scaling factor, and can be used by NER-capable UEs and/or SBFD-capable UEs to determine a configured BI for transmitting a PRACH on an additional RO (e.g., an additional RO associated with NER, and/or an SBFD RO using PRACH resources within an SBFD slot).

In some cases, a first BI scaling factor can be configured and indicated by a network entity for legacy UEs transmitting PRACH on legacy ROs, a second BI scaling factor can be configured and indicated by the network entity for NER-capable UEs transmitting PRACH on additional ROs activated for NER based on network load, and a third BI scaling factor can be configured and indicated by the network entity for SBFD-capable UEs transmitting PRACH on additional ROs (e.g., SBFD ROs) using PRACH resources within SBFD slots of the network entity. In some aspects, the second BI scaling factor for NER-capable UEs can be dynamically indicated by the network entity in combination with the indication of the activation of the additional PRACH resources for NER. In some examples, the third BI scaling factor for SBFD-capable UEs can be selected from candidate BI scaling factor values that are based at least in part on the frequency gap between the RO and the DL subband of the SBFD slot.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a DU, a CU, a RU (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 108. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, network node, apparatus, device, computing system, or the like may include disclosure of the UE, base station, network node, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

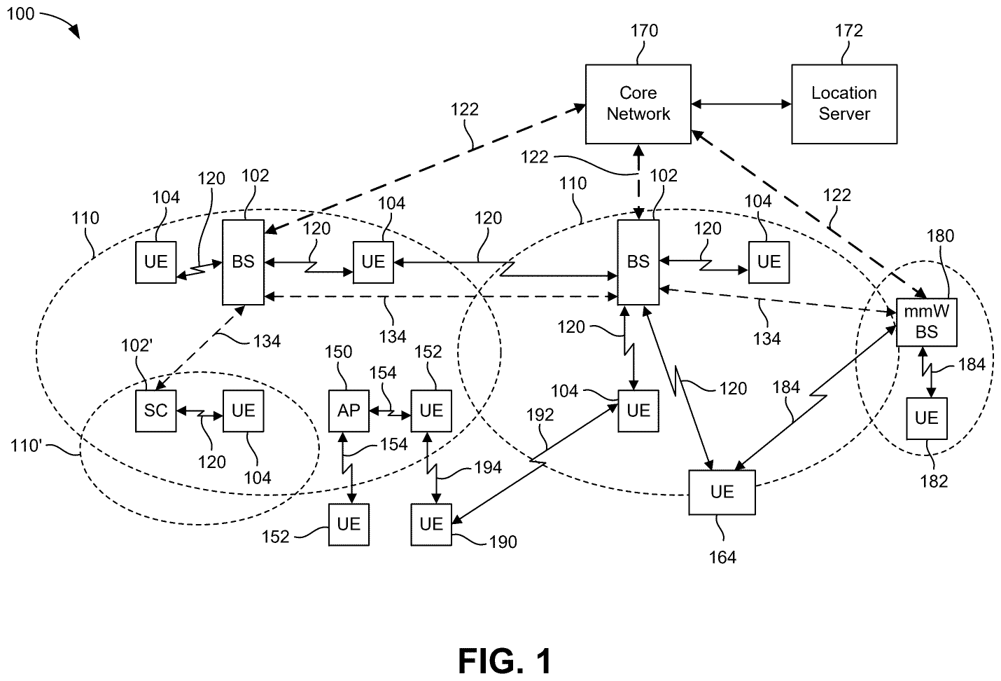

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes. ” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

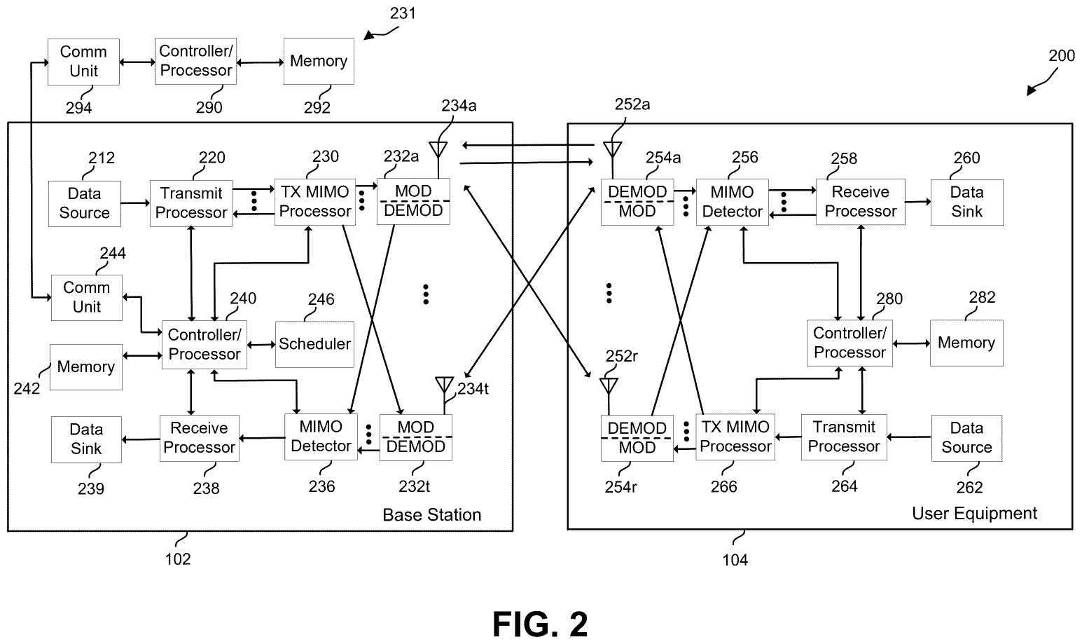

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

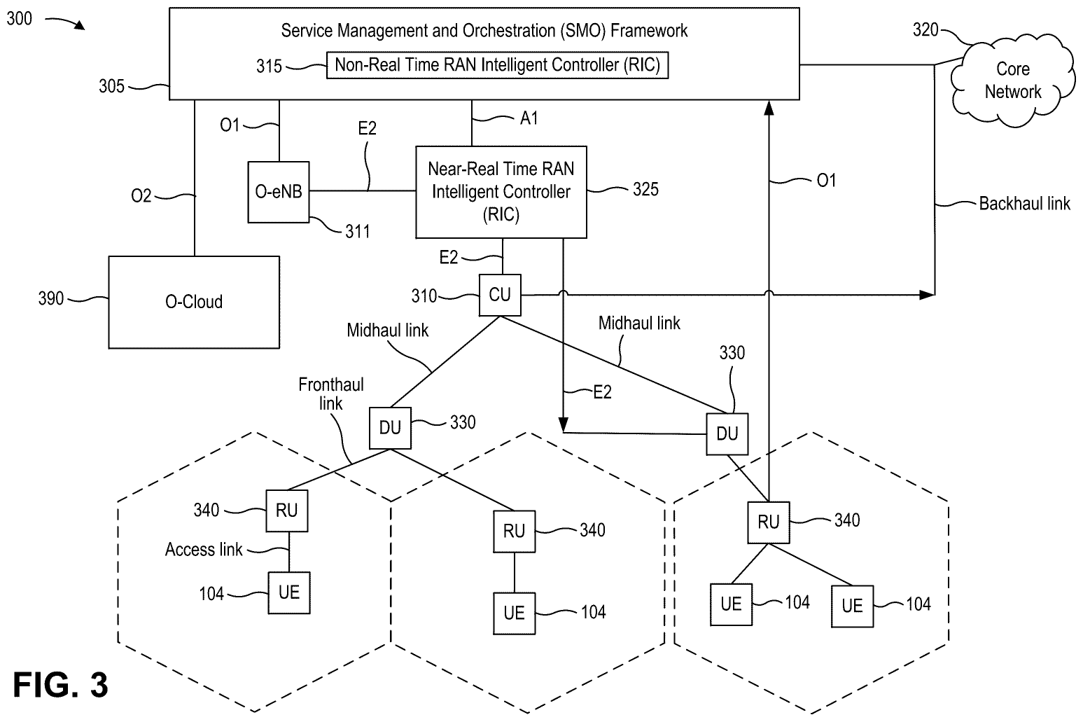

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUs 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via O1) or via creation of RAN management policies (e.g., such as A1 policies).

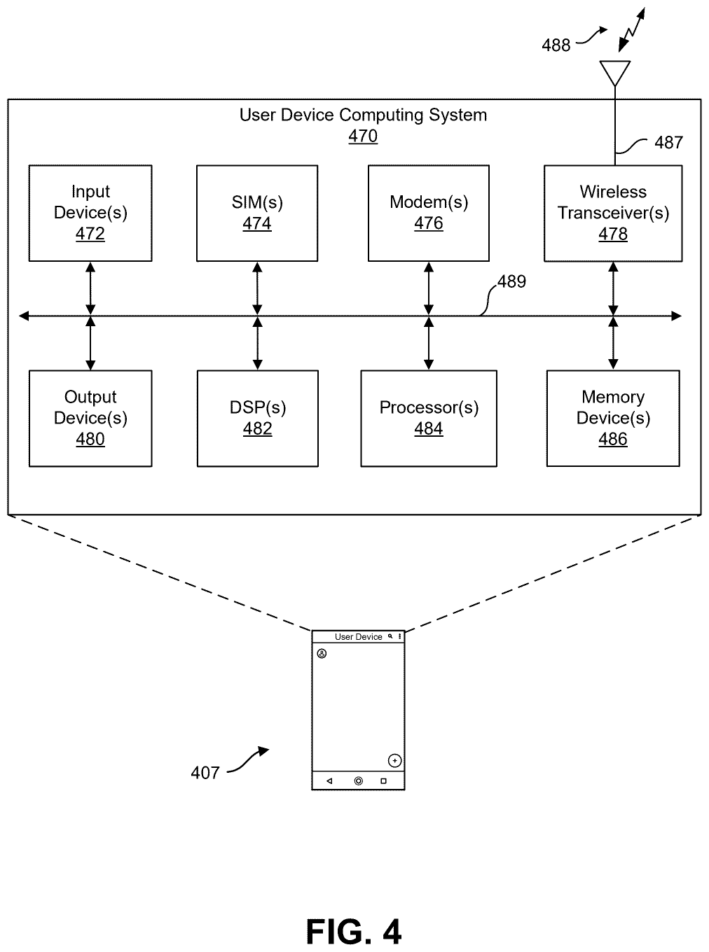

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

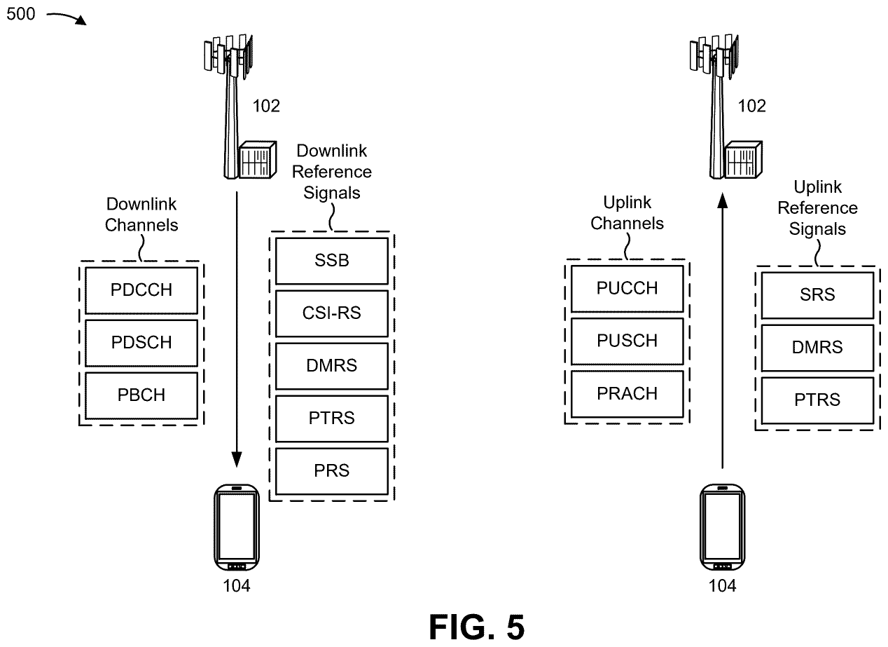

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

As noted above, systems and techniques are provided that can be used to configure a backoff indicator (BI) associated with RACH or PRACH transmission by one or more UEs. The backoff indicator can also be referred to as a backoff indication. In some aspects, the configuration of the BI can be based on a type of PRACH resource and/or RO associated with the BI. For example, a first BI configuration can correspond to backoff performed by UEs attempting to transmit a PRACH using a first type or a first set of PRACH resources and ROs. A second BI configuration can correspond to backoff performed by UEs attempting to transmit a PRACH using a second type or a second set of PRACH resources and ROs.

Network energy savings (NES) can be used to reduce power consumption in 5G NR networks, for example based on using one or more power saving techniques, such as on-demand SSB transmission in secondary cells, adaptation of the periodicity of SSB, paging occasion, and random access occasion based on network conditions, etc. In some cases, NES techniques may be implemented based on the adaptation of SSB in the time domain (e.g., adapting periodicity), the adaptation of PRACH in the time domain, and/or the adaptation of PRACH in the spatial domain (e.g., non-uniform PRACH resources per SSB, etc.). NES implementations can be implemented without negative impact to legacy UEs, where the legacy UEs are UEs that do not support the NES technique(s) of the NES implementation.

In some cases, an NES-based adaptation of PRACH in the time-domain can be associated with additional PRACH resources that are configured for NES-capable UEs. The additional PRACH resources can be in addition to the PRACH resources configured for legacy UEs (e.g., non-NES-capable UEs). NES-capable UEs can utilize the additional PRACH resources and the PRACH resources configured for legacy UEs. In some examples, the configuration of the additional PRACH resources for NES-capable UEs can be provided and/or indicated by semi-static signaling transmitted from a network entity (e.g., base station, gNB, etc.). The additional PRACH resources for NES-capable UEs may be overlapping or non-overlapping with the PRACH resources for legacy (e.g., non-NES-capable) UEs. The additional PRACH resources for NES-capable UEs can be implemented without changes to the PRACH configuration tables used by and associated with the PRACH resources for legacy UEs.

Subband non-overlapping full duplex (SBFD) is a duplex mode that can be used to provide simultaneous transmission and reception on non-overlapping subbands within the same frequency band. For example, a network entity (e.g., base station, gNB, etc.) can use SBFD to transmit and receive simultaneously on different subbands. UEs communicating with a network entity that is using SBFD operation may continue to perform half-duplex mode communications (e.g., the UEs may utilize half-duplex mode communications for a network entity that does implement SBFD operations, and for a network entity that does not implement SBFD operations). In some examples, a network entity may perform SBFD operations within a TDD carrier.

For example, the network entity can provide a semi-static indication of the time location(s) of SBFD subbands to UEs in a radio resource control (RRC) connected mode. In some cases, the indication of the time location(s) of SBFD subbands can be provided within a system information block (SIB). In some cases, the network entity can provide a semi-static indication of the frequency domain location(s) of SBFD subbands to UEs in the RRC connected mode. In some examples, the indication of the frequency location(s) of SBFD subbands can be provided within a SIB. In some examples, SBFD operations by a network entity (e.g., to a UE) can be configured to support random access in SBFD symbols by UEs in RRC connected mode. In some examples, SBFD operations by a network entity (e.g., to a UE) can be configured for a UE in RRC idle and/or RRC inactive mode(s) for random access.

In some examples, SBFD operations by a network entity can be used to reduce uplink (UL) bottlenecks or congestion that may be associated with non-SBFD (e.g., legacy) TDD schemes for communications between UEs and a network entity. A network entity that does not implement SBFD may use separate downlink and uplink slots, where PRACH occasions (e.g., ROs) within a downlink slot are treated as invalid (e.g., the valid ROs for a UE are within the uplink slots configured by or for the non-SBFD network entity). For random access operation for SBFD-aware UEs (e.g., also referred to herein as SBFD-capable UEs) in an RRC connected state, additional PRACH occasions (e.g., ROs) may be configured, corresponding to the ROs that were previously treated as invalid based on being within a downlink slot of a network entity. For example, a network entity implementing SBFD operations can perform simultaneous transmission and reception using a plurality of SBFD symbols or SBFD slots, rather than using separate uplink and downlink slots.

In some examples, random access operations for SBFD-capable UEs in an RRC connected state can be configured based on a single RACH configuration transmitted by the network entity. The single RACH configuration can indicate that the ROs within the UL subband in SBFD symbols are valid for SBFD-capable UEs. In some cases, the ROs within the UL subband in SBFD symbols can be configured as invalid for non-SBFD-capable UEs (e.g., legacy UEs). The ROs within the UL subband in SBFD symbols can be referred to as additional ROs (e.g., additional PRACH resources), where the additional ROs are associated with SBFD.

In some examples, random access operations for SBFD-capable UEs in an RRC connected state can be configured based on two separate RACH configurations. A first RACH configuration can be used to indicate RACH configuration information corresponding to non-SBFD-capable UEs (e.g., legacy UEs) and/or the ROs within the UL subband in non-SBFD symbols. A second RACH configuration can be used to indicate RACH configuration information corresponding to SBFD-capable UEs and/or the ROs within the UL subband in SBFD symbols. For example, the ROs within the UL subband in SBFD symbols can be referred to as additional ROs for SBFD and/or SBFD-capable UEs, and can be configured by the additional (e.g., second) RACH configuration. The ROs within the UL subband in SBFD symbols configured by the additional RACH configuration can be configured as valid for the SBFD-capable UEs, and invalid for the non-SBFD-capable (e.g., legacy) UEs. The ROs within the UL subband in non-SBFD symbols can be valid for both the SBFD-capable UEs and the non-SBFD-capable (e.g., legacy) UEs.

As noted above, NES-capable UEs can be configured with additional PRACH resources and/or additional PRACH occasions (e.g., ROs), where the additional PRACH resources are in addition to the PRACH resources and ROs configured for non-NES-capable (e.g., legacy) UEs, and may be activated based on the network load. SBFD-capable UEs can perform communications during SBFD slots associated with a network entity, in addition to uplink and downlink slots associated with the network entity. The PRACH resources and/or PRACH occasions (e.g., ROs) within the SBFD slots of the network entity can be configured as additional PRACH resources and/or additional ROs, in addition to the PRACH resources and ROs configured within the non-SBFD uplink and downlink slots of the network entity.

As used herein, “additional PRACH resources” can refer to the additional PRACH resources that can be configured for NES (e.g., semi-statically configured PRACH resources that are associated with NES and are activated based on the network load). The term “additional PRACH resources” can refer to the additional PRACH resources that are provided within SBFD slots and are available for SBFD-capable UEs. In some aspects, “additional PRACH resources” can refer to both the additional PRACH resources associated with NES and the additional PRACH resources associated with SBFD.

A UE that is not NES-capable and is not SBFD-capable may be referred to as a “legacy UE.” A legacy UE can transmit PRACH transmissions using a baseline set of ROs that are configured by a network entity (e.g., base station, gNB, etc.) within uplink subbands or slots. The set of baseline ROs used for PRACH transmissions by legacy UEs can also be referred to herein as “legacy ROs.”

An NES-capable UE can refer to a UE that is NES-capable and is not SBFD-capable, and/or can refer to a UE that is both NES-capable and SBFD-capable. An SBFD-capable UE can refer to a UE that is SBFD-capable and is not NES-capable, and/or can refer to a UE that is both NES-capable and SBFD-capable. An NES-capable UE may also be an SBFD-capable, and vice versa. A legacy UE can transmit PRACH transmissions using ROs selected from within the baseline (e.g., legacy) set of ROs configured by the network entity. An NES-capable UE can transmit PRACH transmissions using legacy ROs or additional ROs that are associated with NES and activated based on network load. An SBFD-capable UE can transmit PRACH transmissions using legacy ROs or additional ROs that are within SBFD slots.

Random Access (RA) prioritization is a technique in 5G NR that can be used to manage and prioritize the access of different services and/or UEs to the network. For example, RA prioritization can be used to manage and prioritize network access in examples where network resources are limited, heavily utilized, congested, etc. In some examples, RA prioritization can be configured and/or implemented based on configuration information included within an RA-Prioritization Information Element (IE). For example, the RA-Prioritization IE may include one or more fields indicative of configured values or parameters for configuring prioritized random access. The RA-Prioritization IE can indicate how different RA requests are prioritized by the network.

For example, the RA-Prioritization IE can include a powerRampingStepHighPriority field, indicative of a power ramping step applied for a prioritized random access procedure. The power ramping step can indicate a power increment (e.g., as a dB value, etc.) used by a UE during the RA procedure when a high-priority access is required. The RA-Prioritization IE may include a scalingFactorBI field, indicative of a scaling factor for a backoff indicator (BI) for the prioritized random access procedure. The BI scaling factor may be a value between zero and 1, and can be selected from a plurality of configured candidate values for the BI scaling factor (e.g., 0, 0.25, 0.50, 0.75, etc.). The configured BI scaling factor can be used as a scaling factor for the BI during the random access procedure by a UE. For example, the scalingFactorBI can be used to modify the backoff time for random access attempts by a UE. The BI is an indication transmitted in the Random Access Response (RAR) sent from a network entity (e.g., base station, gNB, etc.) to a UE, in response to the network entity receiving an RA preamble transmitted through PRACH by the UE.

For example, the BI can be an indication within the RAR, where the BI is configured to require the UE to backoff for a configured length of time before the UE transmits another PRACH to the network entity. The scalingFactorBI indicated in the RA-Prioritization IE used to configure prioritized random access can be used to increase the granularity of the various backoff indication time lengths that can be signaled to a UE. For example, the backoff parameter value used for the BI included within the RAR transmitted by a network entity to a UE can be selected from a pre-determined or configured set of candidate backoff parameter values, which may be specified by the network. An example of the configured backoff parameter values that may be used by a network entity in a 5G NR network is illustrated below, in Table 1.

TABLE 1
Example backoff parameter values and corresponding index.

| Index | Backoff Parameter Value (ms) |
|---|---|
| 0 | 0 |
| 1 | 10 |
| 2 | 20 |
| 3 | 30 |
| 4 | 40 |
| 5 | 60 |
| 6 | 80 |
| 7 | 120 |
| 8 | 160 |
| 9 | 240 |
| 10 | 320 |
| 11 | 480 |
| 12 | 960 |
| 13 | Reserved |
| 14 | Reserved |
| 15 | Reserved |

In the example of Table 1, the backoff parameter value used for the BI transmitted from a network entity to a UE is selected from 13 candidate backoff parameter values, and the network entity can configure a UE to backoff from performing further PRACH transmissions for 13 different backoff time lengths. The scalingFactorBI can be used to increase the number of backoff time lengths that can be configured for a UE by the network entity. For example, the RA-Prioritization IE can indicate the scalingFactorBI as a selection between the set of BI scaling factor values comprising 0, 0.25, 0.5, or 0.75.

A UE can be configured to scale the indicated backoff parameter value received in a RAR from the network entity (e.g., backoff time length, in ms) by the particular BI scaling factor value indicated as the scalingFactorBI within the RA-Prioritization IE. A set of four candidate BI scaling factor values (e.g., 0, 0.25, 0.5, 0.75) can increase the number of available backoff time lengths by a factor of four. For example, the four candidate BI scaling factor values 0, 0.25, 0.5, and 0.75 can be combined with the 13 different backoff parameter values of Table 1 to provide a total of 13*4=52 different backoff time lengths that can be signaled from the network entity to a UE, based on each backoff parameter value being scaled according to indicated scalingFactorBI BI scaling factor value. In some examples, a scalingFactorBI of 0 can correspond to an indication that the UE does not have to perform backoff, due to higher priority, and can transmit another PRACH immediately or without delay for a backoff period.

The systems and techniques described herein can be used to configure and/or implement a backoff indication (BI) and/or BI signaling between a network entity and one or more UEs, where the indicated BI is used to apply different backoffs based on the type of RO being used by or supported by a UE for transmitting a PRACH transmission. For example, legacy UEs can utilize a first BI configuration to perform the backoff associated with RA prioritization for PRACH transmissions and/or re-transmission using legacy ROs.

NES-capable UEs can utilize a second BI configuration to perform backoff for RA prioritization for PRACH transmissions and/or re-transmissions using additional ROs that are associated with NES and activated based on network load. In some aspects, an NES-capable UE may utilize the first BI configuration to determine a configured backoff length when the NES-capable UE performs PRACH transmission using a legacy RO, and can utilize the second BI configuration to determine the configured backoff length when performing PRACH transmission using an additional RO (e.g., NES RO).

SBFD-capable UEs can utilize a third BI configuration to perform backoff for RA prioritization for PRACH transmissions and/or re-transmissions using additional ROS that are within SBFD slots configured or indicated by the network entity. In some aspects, an SBFD-capable UE may utilize the first BI configuration to determine a configured backoff length when the SBFD-capable UE performs PRACH transmission using a legacy RO, and can utilize the third BI configuration to determine the configured backoff length when performing PRACH transmission using an additional RO (e.g., SBFD RO).

In some examples, the second BI configuration and the third BI configuration can be the same. For example, a first backoff can be applied for legacy ROs, and the same second backoff can be applied for both additional ROs that are NES ROs and additional ROs that are SBFD ROs. In some aspects, the second BI configuration can be different from the third BI configuration (e.g., with the first backoff applied for legacy ROs, the second backoff applied for NES ROs, the third backoff applied for SBFD ROs).

In some cases, the second and/or third BI configurations associated with the additional ROs (e.g., NES ROs and/or SBFD ROs) can be implemented based on the PRACH transmissions using additional ROs being associated with a lower collision rate than the PRACH transmissions using legacy ROs. For example, NES-capable UEs transmitting PRACH transmissions using an additional NES RO may be associated with a lower collision rate than a UE transmitting PRACH transmissions using a legacy RO. SBFD-capable UEs transmitting PRACH transmissions using an additional SBFD RO may be associated with a lower collision rate than a UE transmitting PRACH transmission using a legacy RO. Based on the lower collision rate associated with PRACH transmissions using the additional ROs, the BI configuration

In one illustrative example, the backoff indication can be configured to cause UEs to apply a shorter backoff value (e.g., backoff time length, etc.) when the UE receives the backoff indication in association with transmitting another PRACH using an additional RO, than if the UE were to receive the backoff indication in association with transmitting another PRACH using a legacy RO.

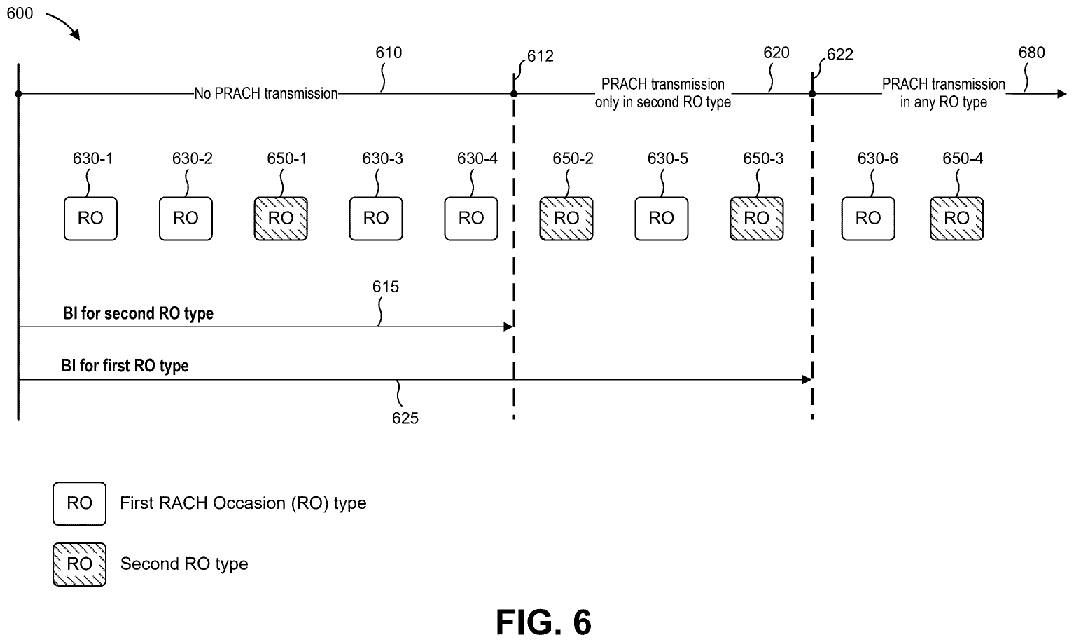

FIG. 6 is a diagram illustrating an example of PRACH transmissions 600 associated with a plurality of ROs, where the plurality of ROs includes a first plurality of ROs of a first type (e.g., legacy ROs) and a second plurality of ROs of a second type (e.g., additional ROs, including NES ROs and/or SBFD ROs) that is different from the first type. The first plurality of ROs (e.g., legacy ROs) may also be referred to as a first set of ROs, a set of ROs associated with a first RO type, a first subset of ROs, a subset of ROs associated with a first RO type, etc. The second plurality of ROs (e.g., additional ROs, including NES ROs and/or SBFD ROs) may also be referred to as a second set of ROs, a set of ROs associated with a second RO type, a second subset of ROs, a subset of ROs associated with the second RO type, etc.

The plurality of ROs associated with the PRACH transmissions 600 can include a set of legacy ROs (e.g., 630-1, 630-2, 630-3, 630-4, 630-5, 630-6, etc.) and a set of additional ROs (e.g., 650-1, 650-2, 650-3, 650-4, etc.). The set of additional ROs can include ROs that are associated with NES (e.g., NES ROs), where the NES ROs may be semi-statically configured for the UE and activated by a network entity based on network load. The set of additional ROs can include ROs that are associated with SBFD (e.g., SBFD ROs), where the SBFD ROs are within SBFD uplink slots of an SBFD-capable network entity. For example, each additional RO of the set of additional ROs 650-1, 650-2, 650-3, 650-4 can be an NES RO or an SBFD RO. Each legacy RO of the set of legacy ROs 630-1, 630-2, 630-3, 630-4, 630-5, 630-6 can be a non-NES and non-SBFD RO.

In one illustrative example, a BI indicated or signaled by a network entity to one or more UEs performing the PRACH transmissions 600 and/or transmitting using the ROs of FIG. 6 can be interpreted differently between the set of legacy ROs and the set of additional ROs. For example, during a first time period 610, no PRACH transmission is performed using either legacy ROs or additional ROs. For example, the first time period 610 can correspond to a backoff period measured starting from a time when a BI is received by the UE or becomes active based on the UE receiving an indicated BI within an RAR from a network entity having received a previous PRACH transmission from the UE. During the backoff of the first time period 610, no PRACH transmissions are performed using the legacy ROs 630-1, 630-2, 630-3, and 630-4 and no PRACH transmission are performed using the additional RO 650-1.

The first time period 610 can be implemented as a backoff corresponding to or using a first BI configuration. For example, the first time period 610 can correspond to a backoff that is implemented for the set of additional ROs 650-1, 650-2, 650-3, 650-4 (e.g., NES ROs and/or SBFD ROs), associated with a configured BI 615 for the additional RO type(s).

A second time period 620 can correspond to a backoff that is configured for legacy ROs only. For example, the second time period 620 can correspond to a configured backoff on legacy ROs, associated with a configured BI 625 for the legacy ROs. During the second time period 620, the backoff and BI 615 for the additional ROs has ended, and PRACH transmissions are permitted for the additional ROs 650-2, 650-3, 650-4, etc., that are after the end time 612 of the configured BI 615 (e.g., the end time of the first time period 610) for the additional RO type(s).

Within the second time period 620, the configured BI 615 for the additional RO type(s) is no longer active (e.g., backoff on additional ROs has ended), while the configured BI 625 for the legacy ROs remains active (e.g., backoff on legacy ROs is still configured for the UE). For example, within the second time period 620, an NES-capable UE and/or an SBFD-capable UE may perform PRACH transmission using a corresponding NES or SBFD RO that is included within the subset of additional ROs 650-2—and 650-3 that are within the second time period 620 and/or after the expiration of the configured BI 615 for the additional ROs. Within the second time period 620, the same NES-capable UE and/or SBFD-capable UE is configured to not perform PRACH transmission using the legacy RO 630-5, based on the configured BI 625 for legacy ROs remaining active.

Within the second time period 620, a legacy UE does not perform PRACH transmission, based on the legacy UE not supporting the additional ROs 650-2 and 650-3 for which PRACH transmission is allowed, and the configured BI 625 for the legacy RO 630-5 remaining active.

The configured BI 625 for the legacy ROs ends at a second time 622 (e.g., which can be the ending time of the second time period 620), and PRACH transmissions can be performed using legacy ROs that are after (e.g., later in time than) the end of the configured BI 625 for the legacy ROs. For example, a time period 680 that is after the expiration of the configured BI 625 for legacy ROs and after the earlier expiration of the configured BI 615 for the additional RO type(s), can correspond to a UE being permitted to perform PRACH transmission using any RO that is available to or supported by the UE. For example, during the time period 680 when no backoff or BI remains active, a legacy UE can perform PRACH transmission using legacy ROs (e.g., such as legacy RO 630-6). NES-capable and/or SBFD-capable UEs can perform PRACH transmission using legacy ROs and/or using the additional ROs (e.g., such as legacy RO 630-6 and additional RO 650-4).

In some examples, the backoff indication associated with additional ROs (e.g., NES ROs and/or SBFD ROs) can be determined by a UE based on the UE applying a configured offset to a received backoff indication from a network entity. For example, the network entity can use one or more RRC messages to indicate the configured offset for determining the additional RO type(s) configured BI 615, where the configured offset is indicative of the difference (e.g., offset) between the additional RO configured BI 615 and the legacy RO configured BI 625. In some aspects, an NES-capable UE or SBFD-capable UE can be RRC configured with an indication of the offset for determining the backoff to apply for PRACH transmissions using additional ROs, and can receive an RAR with an indicated BI corresponding to the legacy RO BI 625. The NES-capable UE or SBFD-capable UE can determine the additional RO configured BI 615 by subtracting the configured offset from the legacy RO BI 625.

In some examples, the configured offset can be a value in units of time (e.g., milliseconds (ms), etc.). In some cases, the configured offset can be a value corresponding to a backoff indication index (e.g., such as the backoff indication indices of Table 1), where the UE is configured to use a received backoff indication index as a lookup into pre-determined or configured mapping information between the indices and a corresponding backoff value (e.g., backoff time length) to apply for each index.

For example, an indicated BI with an index value of 2 may be mapped to a backoff value of 20 ms, using the mapping information of Table 1. The BI index of 2, and the mapped backoff value of 20 ms, can correspond to and may be used by a UE to implement the backoff 625 for PRACH transmission on a legacy RO. The configured offset can be indicated from the network entity to the UE, for example with an index-based offset value of 3. The UE can determine the BI index for PRACH transmission on an additional RO as the legacy RO BI index received from the network entity (e.g., 2) plus the configured index-based offset value (e.g., 3), to determine the additional RO BI index as 2+3=5.

In another illustrative example, the UE can be configured with a time-based offset information from the network entity. For example, a UE can be configured with a time-based offset with a value of 15 ms. The 15 ms time-based offset configuration information can be applied by the UE to the backoff value (e.g., backoff time length) that is indicated from the network entity to the UE in the RAR. The time-based offset can be applied to a backoff value that is also in units of time, where the UE receives the backoff value in the RAR (e.g., the 15 ms time-based offset can be applied to a 20 ms legacy RO configured BI 615 indicated in an RAR received by the UE from the network entity), or where the UE receives a BI index value in the RAR and determines the corresponding backoff value for the legacy RO configured BI 615 by using the mapping information (e.g., such as the mapping information of Table 1) to obtain the backoff value that is mapped to the received BI index value.

In some aspects, the legacy RO backoff configuration and the additional RO backoff configuration can be implemented using additional columns added to the mapping information for the BI indices. For example, Table 1 shows an example mapping between BI index values and the corresponding backoff parameter value (e.g., backoff time length) to be applied by a UE for PRACH transmissions using legacy ROs. A second column can be added to the mapping information to indicate a corresponding backoff parameter value to be applied by a UE for PRACH transmissions using additional ROs. For example, each BI index (e.g., 0, 1, 2, 3, . . . ) can be mapped to a first backoff value for the configured BI 625 for a legacy RO and a second backoff value for the configured BI 615 for an additional RO. In some cases, a second column can be added indicative of the backoff value configured for the NES RO type of the additional ROs, and a third column can be added indicative of the backoff value configured for the SBFD RO type of the additional ROs.

As noted above, in some aspects, different backoff durations (e.g., backoff time lengths) can be configured for legacy ROs and additional ROs (e.g., NES ROs, SBFD ROs, etc.), based on a network entity signaling different BI indicator values to legacy UEs and to NES- and/or SBFD-capable UEs, or based on legacy UEs and NES- and/or SBFD-capable UEs applying different mapping information to obtain different backoff durations for a particular BI index signaled by the network entity. In these examples, the backoff duration can be adjusted for different RO types (e.g., legacy RO or additional RO) based on an adjustment or configuration applied to the BI indicated to a UE in an RAR from a network entity.

In another illustrative example, the backoff duration can be adjusted for different RO types (e.g., legacy RO or additional RO) based on a network entity configuring a UE with two or more values of a backoff indicator scaling factor. For example, a UE can apply a first configured BI scaling factor to the BI indication received from the network entity, to thereby obtain the backoff duration for legacy ROs, and the UE can apply a second configured BI scaling factor to the same BI indication to thereby obtain the backoff duration for additional ROs (e.g., NES ROs and/or SBFD ROs). In some aspects, a UE can be configured with two or more values of the backoff indicator scaling factor included in the scalingFactorBI field of an RA-Prioritization IE.

As noted above, the scalingFactorBI field can indicate a backoff indicator scaling factor with a value between zero and 1, where a value of zero indicates that the UE does not have to perform backoff (e.g., applying scalingFactorBI=0 to the BI indication from the network entity corresponds to the UE determining a calculated backoff duration also equal to 0, and a backoff duration of zero can be the same as the UE not performing backoff).

In some examples, a first configured scalingFactorBI value is configured for the UE based on scaling factor configuration information received by the UE from a network entity (e.g., base station, gNB, etc.), where the UE is configured to apply the first configured scalingFactorBI for PRACH transmissions using or associated with one or more legacy ROs. A second configured scalingFactorBI value can be configured for the UE to cause the UE to apply the second configured scalingFactorBI for PRACH transmissions using or associated with one or more additional ROs. In some aspects, the same value of the second configured scalingFactorBI value can be used by the UE to determine the calculated backoff duration for additional ROs that are NES ROs, and for additional ROs that SBFD ROs. In some examples, the second configured scalingFactorBI value can be used by the UE to determine the calculated backoff duration for additional NES ROs, and a third configured scalingFactorBI value can be used by the UE to determine a calculated backoff duration for additional SBFD ROs.

In some aspects, a scalingFactorBI value can be configured for determining a backoff duration associated with PRACH transmissions using additional ROs for NES, based on dynamic indication of the NES RO backoff scalingFactorBI value from the network entity to the UE. For example, a scalingFactorBI value configured for the additional ROs for NES can be dynamically indicated to the UE in combination with the activation of the additional PRACH resources for NES. The additional ROs for NES utilize additional PRACH resources that can be activated based on network load, and information transmitted from the network entity to the UE indicative of the activation of an additional PRACH resource for NES can additionally be indicative of the configured scalingFactorBI value for backoff on the activated additional PRACH resources and corresponding additional ROs for NES.

In some aspects, a scalingFactorBI value can be configured for backoff on an SBFD RO that is included within an SBFD slot and/or that is associated with SBFD symbols. In some examples, the scalingFactorBI configured for backoff on one or more SBFD ROs can have a value based on a frequency gap between the SBFD RO and the DL subband of the SBFD slot. For example, an SBFD slot can include and/or be associated with a DL subband and one or more SBFD ROs. The value of the scalingFactorBI value for backoff associated with one or more of the SBFD ROs in the SBFD slot can be determined based on the frequency gap (e.g., different in frequency) between the SBFD ROs and the DL subband of the SBFD slot.

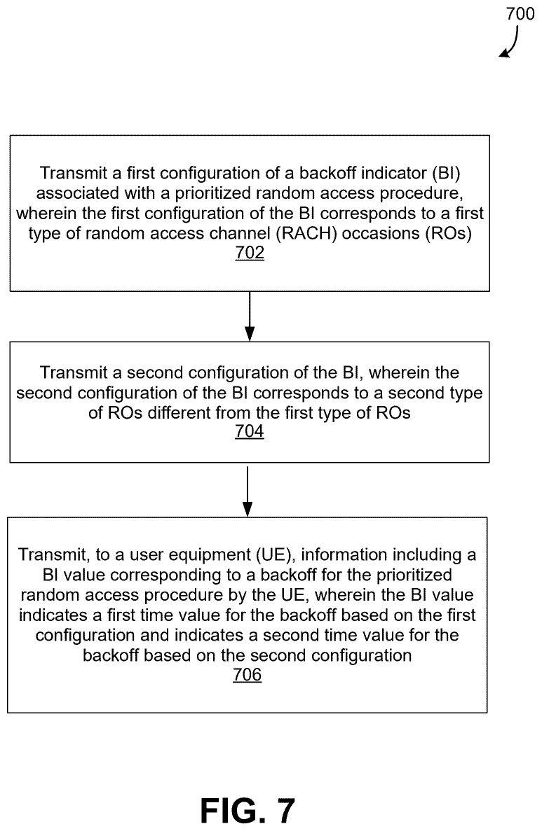

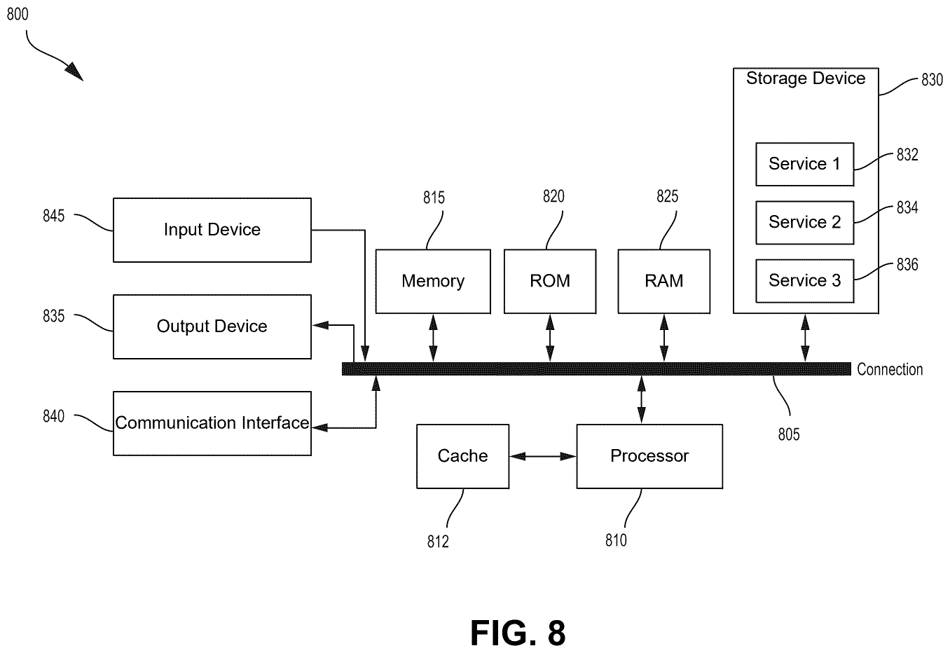

FIG. 7 is a flowchart diagram illustrating an example of a process 700 for wireless communication. The process 700 may be performed by a network entity or network device (or apparatus) or a component (e.g., a chipset, codec, etc.) of the network entity or device. The network entity may be a UE (e.g., the UE 104 of FIG. 1, FIG. 2, and/or FIG. 3, the wireless device 407 of FIG. 4, or other UE). The network entity (e.g., UE) can be a mobile device (e.g., a mobile phone), a network-connected wearable such as a watch, an extended reality (XR) device (e.g., a virtual reality (VR) device or augmented reality (AR) device), a vehicle or component or system of a vehicle, or other type of computing device configured to perform wireless communications. The operations of the process 700 may be implemented as software components that are executed and run on one or more processors (e.g., the transmit processor 264, the receive processor 258, the TX MIMO processor 266, the MIMO detector 256 of FIG. 2, the processor(s) 484 of FIG. 4, the processor 810 of FIG. 8, or other processor(s)). Further, the transmission and reception of signals by the network entity in the process 1000 may be enabled, for example, by one or more antennas, one or more transceivers (e.g., wireless transceiver(s)), and/or other communication components (e.g., the transmit processor 264, the receive processor 258, the TX MIMO processor 266, the MIMO detector 256, the modulator(s)/demodulator(s) 254a through 254t, and/or the antenna(es) 252a through 252t of FIG. 2, the antenna(es) 487 of FIG. 4, the wireless transceiver(s) 478 of FIG. 4, the communication interface 840 of FIG. 8, or other antennae(s), transceiver(s), and/or component(s)).

At block 702, the network entity (or component thereof) can transmit a first configuration of a backoff indicator (BI) associated with a prioritized random access procedure, wherein the first configuration of the BI corresponds to a first type of random access channel (RACH) occasions (ROs).

For example, the first configuration of the BI can correspond to the BI for the first RO type 625 of FIG. 6, and/or one or more of the RACH occasions of the first type (e.g., ROs 630-1, 6730-2, 630-3, 630-4, 630-5, 630-6, etc.). The first configuration of the BI can be transmitted to a UE. In some cases, the first type of ROs is associated with configured physical random access channel (PRACH) resources, and a second type of ROs is associated with additional PRACH resources different from the configured PRACH resources. In some cases, the first type of ROs comprises ROs not associated with network energy savings (NES) and not included within a subband full duplex (SBFD) slot configured by the network entity.

At block 704, the network entity (or component thereof) can transmit a second configuration of the BI, wherein the second configuration of the BI corresponds to a second type of ROs different from the first type of ROs.

For example, the second configuration of the BI can correspond to the BI for the second RO type 615 of FIG. 6, and/or one or more of the RACH occasions of the second type (e.g., RO 650-1, 650-2, 650-3, 650-4, etc.). The second configuration of the BI can be transmitted to a UE. The first and second configurations of the BI can be transmitted to the same UE. In some cases, the first type of ROs is associated with configured physical random access channel (PRACH) resources, and a second type of ROs is associated with additional PRACH resources different from the configured PRACH resources.

In some cases, the second type of ROs is associated with additional PRACH resources different from the configured PRACH resources. For example, the additional PRACH resources may comprise one or more of: PRACH resources configured for network energy savings (NES) by the network entity or PRACH resources configured for subband non-overlapping full duplex (SBFD) transmissions by the network entity. In some cases, the second type of ROs includes one or more of: ROs associated with network energy savings (NES), or ROs included within a subband full duplex (SBFD) slot configured by the network entity. In some cases, the second configuration comprises a second RACH configuration corresponding to the second type of ROs.

At block 706, the network entity (or component thereof) can transmit, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

In some examples, the BI value comprises a particular index included in mapping information between a plurality of indices and a corresponding time value for each index of the plurality of indices. The first configuration can cause the UE to perform the backoff using a first mapping information for the first type of ROs, where the first mapping information maps the particular index to the first time value for the backoff. The second configuration can cause the UE to perform the backoff using a second mapping information for the second type of ROs, where the second mapping information maps the particular index to the second time value for the backoff.

In some cases, the first configuration indicates the first time value is determined based on the BI value without adjustment. The second configuration can be indicative of an offset from the first time value, where the second time value comprises the first time value adjusted based on the offset. In some examples, the offset is indicated using units of time. In some cases, the offset is indicated as a difference between a backoff index associated with the first time value and a backoff index associated with the second time value. In some examples, the network entity (or component thereof) can be configured to transmit, to the UE, a radio resource control (RRC) message indicative of the offset.

In some cases, the BI value is indicative of a backoff duration and the first configuration is indicative of a first configured scaling factor. The first time value can be determined based on the first configured scaling factor and the backoff duration. In some examples, the second configuration is indicative of a second configured scaling factor and the second time value is determined based on the second configured scaling factor and the backoff duration. The second configured scaling factor is different from the first configured scaling factor.

In some examples, the second configured scaling factor corresponds to ROs associated with network energy savings (NES). In some examples, the network entity (or component thereof) can be configured to transmit dynamic indication information configured to activate one or more physical random access channel (PRACH) resources for NES. The second configured scaling factor can be included in the dynamic indication information.

In some cases, the second configured scaling factor corresponds to ROs included within a subband full duplex (SBFD) slot associated with the network entity. In some examples, the second configured scaling factor is based on a frequency gap between an RO within the SBFD slot and a downlink subband within the SBFD slot.

In some examples, the network entity (or component thereof) can be configured to receive, from the UE, a first physical random access channel (PRACH) transmission. The network entity (or component thereof) can transmit, to the UE, a random access response (RAR) including the information including the BI value in response to the first PRACH transmission. The network entity (or component thereof) can receive, from the UE, a second PRACH transmission using an RO of the first type of ROs, where a time delay between the first PRACH transmission and the second transmission is greater than or equal to the first time value.

In some cases, the network entity (or component thereof) can be configured to receive, from the UE, a first physical random access channel (PRACH) transmission. The network entity (or component thereof) can transmit, to the UE, a random access response (RAR) including the information including the BI value in response to the first PRACH transmission. The network entity (or component thereof) can receive, from the UE, a second PRACH transmission using an RO of the second type of ROs, where a time delay between the first PRACH transmission and the second transmission is greater than or equal to the second time value.

In some cases, the computing device or apparatus configured to perform the process 700 and may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 700 is illustrated as a logical flow diagram, the operation of which represents a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 700 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some aspects, computing system 800 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 814 of high-speed memory connected directly with, in close proximity to, or integrated as part of processor 810.

Processor 810 may include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some aspects, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. A network entity for wireless communication, comprising: at least one memory; and at least one processor coupled to the at least one memory, wherein the network entity is configured to: transmit a first configuration of a backoff indicator (BI) associated with a prioritized random access procedure, wherein the first configuration of the BI corresponds to a first type of random access channel (RACH) occasions (ROs); transmit a second configuration of the BI, wherein the second configuration of the BI corresponds to a second type of ROs different from the first type of ROs; and transmit, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

Aspect 2. The network entity of Aspect 1, wherein the first type of ROs is associated with configured physical random access channel (PRACH) resources, and wherein the second type of ROs is associated with additional PRACH resources different from the configured PRACH resources.

Aspect 3. The network entity of Aspect 2, wherein the additional PRACH resources comprise one or more of: PRACH resources configured for network energy savings (NES) by the network entity or PRACH resources configured for subband non-overlapping full duplex (SBFD) transmissions by the network entity.

Aspect 4. The network entity of any of Aspects 1 to 3, wherein the second type of ROs includes one or more of: ROs associated with network energy savings (NES), or ROs included within a subband full duplex (SBFD) slot configured by the network entity.

Aspect 5. The network entity of Aspect 4, wherein the first type of ROs comprises ROs not associated with NES and not included within an SBFD slot configured by the network entity.

Aspect 6. The network entity of any of Aspects 1 to 5, wherein: the first configuration comprises a first RACH configuration corresponding to the first type of ROs; and the second configuration comprises a second RACH configuration corresponding to the second type of ROs.

Aspect 7. The network entity of any of Aspects 1 to 6, wherein: the BI value comprises a particular index included in mapping information between a plurality of indices and a corresponding time value for each index of the plurality of indices; the first configuration causes the UE to perform the backoff using a first mapping information for the first type of ROs, wherein the first mapping information maps the particular index to the first time value for the backoff; and the second configuration causes the UE to perform the backoff using a second mapping information for the second type of ROs, wherein the second mapping information maps the particular index to the second time value for the backoff.

Aspect 8. The network entity of any of Aspects 1 to 7, wherein: the first configuration indicates the first time value is determined based on the BI value without adjustment; and the second configuration is indicative of an offset from the first time value, wherein the second time value comprises the first time value adjusted based on the offset.

Aspect 9. The network entity of Aspect 8, wherein the offset is indicated using units of time, or wherein the offset is indicated as a difference between a backoff index associated with the first time value and a backoff index associated with the second time value.

Aspect 10. The network entity of any of Aspects 8 to 9, wherein the network entity is configured to transmit, to the UE, a radio resource control (RRC) message indicative of the offset.

Aspect 11. The network entity of any of Aspects 1 to 10, wherein: the BI value is indicative of a backoff duration; the first configuration is indicative of a first configured scaling factor, wherein the first time value is determined based on the first configured scaling factor and the backoff duration; and the second configuration is indicative of a second configured scaling factor, wherein the second time value is determined based on the second configured scaling factor and the backoff duration, the second configured scaling factor different from the first configured scaling factor.

Aspect 12. The network entity of Aspect 11, wherein: the second configured scaling factor corresponds to ROs associated with network energy savings (NES); the network entity is configured to transmit dynamic indication information configured to activate one or more physical random access channel (PRACH) resources for NES; and the second configured scaling factor is included in the dynamic indication information.

Aspect 13. The network entity of any of Aspects 11 to 12, wherein: the second configured scaling factor corresponds to ROs included within a subband full duplex (SBFD) slot associated with the network entity; and the second configured scaling factor is based on a frequency gap between an RO within the SBFD slot and a downlink subband within the SBFD slot.

Aspect 14. The network entity of any of Aspects 1 to 13, wherein the network entity is configured to: receive, from the UE, a first physical random access channel (PRACH) transmission; transmit, to the UE, a random access response (RAR) including the information including the BI value in response to the first PRACH transmission; and receive, from the UE, a second PRACH transmission using an RO of the first type of ROs, wherein a time delay between the first PRACH transmission and the second transmission is greater than or equal to the first time value.

Aspect 15. The network entity of any of Aspects 1 to 14, wherein the network entity is configured to: receive, from the UE, a first physical random access channel (PRACH) transmission; transmit, to the UE, a random access response (RAR) including the information including the BI value in response to the first PRACH transmission; and receive, from the UE, a second PRACH transmission using an RO of the second type of ROs, wherein a time delay between the first PRACH transmission and the second transmission is greater than or equal to the second time value.

Aspect 16. A method for wireless communication by a network entity, comprising: transmitting a first configuration of a backoff indicator (BI) associated with a prioritized random access procedure, wherein the first configuration of the BI corresponds to a first type of random access channel (RACH) occasions (ROs); transmitting a second configuration of the BI, wherein the second configuration of the BI corresponds to a second type of ROs different from the first type of ROs; and transmitting, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

Aspect 17. The method of Aspect 16, wherein the first type of ROs is associated with configured physical random access channel (PRACH) resources, and wherein the second type of ROs is associated with additional PRACH resources different from the configured PRACH resources.

Aspect 18. The method of Aspect 17, wherein the additional PRACH resources comprise one or more of: PRACH resources configured for network energy savings (NES) by the network entity or PRACH resources configured for subband non-overlapping full duplex (SBFD) transmissions by the network entity.

Aspect 19. The method of any of Aspects 16 to 18, wherein the second type of ROs includes one or more of: ROs associated with network energy savings (NES), or ROs included within a subband full duplex (SBFD) slot configured by the network entity.

Aspect 20. The method of Aspect 19, wherein the first type of ROs comprises ROs not associated with NES and not included within an SBFD slot configured by the network entity.

Aspect 21. The method of any of Aspects 16 to 20, wherein: the first configuration comprises a first RACH configuration corresponding to the first type of ROs; and the second configuration comprises a second RACH configuration corresponding to the second type of ROs.

Aspect 22. The method of any of Aspects 16 to 21, wherein: the BI value comprises a particular index included in mapping information between a plurality of indices and a corresponding time value for each index of the plurality of indices; the first configuration causes the UE to perform the backoff using a first mapping information for the first type of ROs, wherein the first mapping information maps the particular index to the first time value for the backoff; and the second configuration causes the UE to perform the backoff using a second mapping information for the second type of ROs, wherein the second mapping information maps the particular index to the second time value for the backoff.

Aspect 23. The method of any of Aspects 16 to 22, wherein: the first configuration indicates the first time value is determined based on the BI value without adjustment; and the second configuration is indicative of an offset from the first time value, wherein the second time value comprises the first time value adjusted based on the offset.

Aspect 24. The method of Aspect 23, wherein the offset is indicated using units of time, or wherein the offset is indicated as a difference between a backoff index associated with the first time value and a backoff index associated with the second time value.

Aspect 25. The method of any of Aspects 23 to 24, further comprising transmitting, to the UE, a radio resource control (RRC) message indicative of the offset.

Aspect 26. The method of any of Aspects 16 to 25, wherein: the BI value is indicative of a backoff duration; the first configuration is indicative of a first configured scaling factor, wherein the first time value is determined based on the first configured scaling factor and the backoff duration; and the second configuration is indicative of a second configured scaling factor, wherein the second time value is determined based on the second configured scaling factor and the backoff duration, the second configured scaling factor different from the first configured scaling factor.

Aspect 27. The method of Aspect 26, wherein: the second configured scaling factor corresponds to ROs associated with network energy savings (NES); the method further comprises transmitting dynamic indication information configured to activate one or more physical random access channel (PRACH) resources for NES; and the second configured scaling factor is included in the dynamic indication information.

Aspect 28. The method of any of Aspects 26 to 27, wherein: the second configured scaling factor corresponds to ROs included within a subband full duplex (SBFD) slot associated with the network entity; and the second configured scaling factor is based on a frequency gap between an RO within the SBFD slot and a downlink subband within the SBFD slot.

Aspect 29. The method of any of Aspects 16 to 28, further comprising: receiving, from the UE, a first physical random access channel (PRACH) transmission; transmitting, to the UE, a random access response (RAR) including the information including the BI value in response to the first PRACH transmission; and receiving, from the UE, a second PRACH transmission using an RO of the first type of ROs, wherein a time delay between the first PRACH transmission and the second transmission is greater than or equal to the first time value.

Aspect 30. The method of any of Aspects 16 to 29, further comprising: receiving, from the UE, a first physical random access channel (PRACH) transmission; transmitting, to the UE, a random access response (RAR) including the information including the BI value in response to the first PRACH transmission; and receiving, from the UE, a second PRACH transmission using an RO of the second type of ROs, wherein a time delay between the first PRACH transmission and the second transmission is greater than or equal to the second time value.

Aspect 31. A method for wireless communication, comprising performing operations according to any of Aspects 1 to 15.

Aspect 32. A non-transitory computer-readable storage medium comprising instructions stored thereon which, when executed by at least one processor, causes the at least one processor to perform operations according to any of Aspects 1 to 15.

Aspect 33. A non-transitory computer-readable storage medium comprising instructions stored thereon which, when executed by at least one processor, causes the at least one processor to perform operations according to any of Aspects 16 to 30.

Aspect 34. An apparatus for wireless communication comprising one or more means for performing operations according to any of Aspects 1 to 15.

Aspect 35. An apparatus for wireless communication comprising one or more means for performing operations according to any of Aspects 16 to 30.

What is claimed is:

1. A network entity for wireless communication, comprising:
at least one memory; and
at least one processor coupled to the at least one memory, wherein the network entity is configured to:
transmit a first configuration of a backoff indicator (BI) associated with a prioritized random access procedure, wherein the first configuration of the BI corresponds to a first type of random access channel (RACH) occasions (ROs);
transmit a second configuration of the BI, wherein the second configuration of the BI corresponds to a second type of ROs different from the first type of ROs; and
transmit, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

2. The network entity of claim 1, wherein the first type of ROs is associated with configured physical random access channel (PRACH) resources, and wherein the second type of ROs is associated with additional PRACH resources different from the configured PRACH resources.

3. The network entity of claim 2, wherein the additional PRACH resources comprise one or more of: PRACH resources configured for network energy savings (NES) by the network entity or PRACH resources configured for subband non-overlapping full duplex (SBFD) transmissions by the network entity.

4. The network entity of claim 1, wherein the second type of ROs includes one or more of: ROs associated with network energy savings (NES), or ROs included within a subband full duplex (SBFD) slot configured by the network entity.

5. The network entity of claim 4, wherein the first type of ROs comprises ROs not associated with NES and not included within an SBFD slot configured by the network entity.

6. The network entity of claim 1, wherein:
the first configuration comprises a first RACH configuration corresponding to the first type of ROs; and
the second configuration comprises a second RACH configuration corresponding to the second type of ROs.

7. The network entity of claim 1, wherein:
the BI value comprises a particular index included in mapping information between a plurality of indices and a corresponding time value for each index of the plurality of indices;
the first configuration causes the UE to perform the backoff using a first mapping information for the first type of ROs, wherein the first mapping information maps the particular index to the first time value for the backoff; and
the second configuration causes the UE to perform the backoff using a second mapping information for the second type of ROs, wherein the second mapping information maps the particular index to the second time value for the backoff.

8. The network entity of claim 1, wherein:
the first configuration indicates the first time value is determined based on the BI value without adjustment; and
the second configuration is indicative of an offset from the first time value, wherein the second time value comprises the first time value adjusted based on the offset.

9. The network entity of claim 8, wherein the offset is indicated using units of time, or wherein the offset is indicated as a difference between a backoff index associated with the first time value and a backoff index associated with the second time value.

10. The network entity of claim 8, wherein the network entity is configured to transmit, to the UE, a radio resource control (RRC) message indicative of the offset.

11. The network entity of claim 1, wherein:
the BI value is indicative of a backoff duration;
the first configuration is indicative of a first configured scaling factor, wherein the first time value is determined based on the first configured scaling factor and the backoff duration; and
the second configuration is indicative of a second configured scaling factor, wherein the second time value is determined based on the second configured scaling factor and the backoff duration, the second configured scaling factor different from the first configured scaling factor.

12. The network entity of claim 11, wherein:
the second configured scaling factor corresponds to ROs associated with network energy savings (NES);
the network entity is configured to transmit dynamic indication information configured to activate one or more physical random access channel (PRACH) resources for NES; and
the second configured scaling factor is included in the dynamic indication information.

13. The network entity of claim 11, wherein:
the second configured scaling factor corresponds to ROs included within a subband full duplex (SBFD) slot associated with the network entity; and
the second configured scaling factor is based on a frequency gap between an RO within the SBFD slot and a downlink subband within the SBFD slot.

14. The network entity of claim 1, wherein the network entity is configured to:
receive, from the UE, a first physical random access channel (PRACH) transmission;
transmit, to the UE, a random access response (RAR) including the information including the BI value in response to the first PRACH transmission; and
receive, from the UE, a second PRACH transmission using an RO of the first type of ROs, wherein a time delay between the first PRACH transmission and the second transmission is greater than or equal to the first time value.

15. The network entity of claim 1, wherein the network entity is configured to:
receive, from the UE, a first physical random access channel (PRACH) transmission;
transmit, to the UE, a random access response (RAR) including the information including the BI value in response to the first PRACH transmission; and
receive, from the UE, a second PRACH transmission using an RO of the second type of ROs, wherein a time delay between the first PRACH transmission and the second transmission is greater than or equal to the second time value.

16. A method for wireless communication by a network entity, comprising:
transmitting a first configuration of a backoff indicator (BI) associated with a prioritized random access procedure, wherein the first configuration of the BI corresponds to a first type of random access channel (RACH) occasions (ROs);
transmitting a second configuration of the BI, wherein the second configuration of the BI corresponds to a second type of ROs different from the first type of ROs; and
transmitting, to a user equipment (UE), information including a BI value corresponding to a backoff for the prioritized random access procedure by the UE, wherein the BI value indicates a first time value for the backoff based on the first configuration and indicates a second time value for the backoff based on the second configuration.

17. The method of claim 16, wherein the first type of ROs is associated with configured physical random access channel (PRACH) resources, and wherein the second type of ROs is associated with additional PRACH resources different from the configured PRACH resources.

18. The method of claim 17, wherein the additional PRACH resources comprise one or more of: PRACH resources configured for network energy savings (NES) by the network entity or PRACH resources configured for subband non-overlapping full duplex (SBFD) transmissions by the network entity.

19. The method of claim 16, wherein the second type of ROs includes one or more of: ROs associated with network energy savings (NES), or ROs included within a subband full duplex (SBFD) slot configured by the network entity.

20. The method of claim 19, wherein the first type of ROs comprises ROs not associated with NES and not included within an SBFD slot configured by the network entity.
